(19) United States
(12) Patent Application Publication
(10) Pub. No.: US 2024/0213679 A1
(43) Pub. Date: Jun. 27, 2024

(54) ANTENNA STRUCTURE, AND MOTION RECOGNITION SENSOR, RADAR SENSOR AND DISPLAY DEVICE INCLUDING THE SAME

(71) Applicant: DONGWOO FINE-CHEM CO., LTD., Jeollabuk-do (KR)

(72) Inventors: SUNG JOON HONG, Jeollabuk-do (KR); KI HUN SUNG, Jeollabuk-do (KR); DO HYOUNG KWON, Jeollabuk-do (KR); YOON HO HUH, Jeollabuk-do (KR)

(21) Appl. No.: 18/391,956

(22) Filed: Dec. 21, 2023

(30) Foreign Application Priority Data
Dec. 23, 2022 (KR) 10-2022-0183675

(51) Int. Cl. H01Q 9/04; G01S 13/62; H01Q 1/24; H01Q 1/48

(52) U.S. Cl. CPC H01Q 9/0407; G01S 13/62; H01Q 1/243; H01Q 1/48

(57) ABSTRACT

An antenna structure includes a plurality of first antenna units arranged along a first direction, and a second antenna unit disposed in a second direction perpendicular to the first direction with respect to one of the first antenna units. Each of the first antenna units includes a first radiator, a first transmission line connected to the first radiator, and a first sub-ground disposed around the first transmission line. The second antenna unit includes a second radiator and a second transmission line connected to the second radiator.

### PRIORITY

This application claims the benefit under 35 USC § 119 of Korean Patent Application No. 10-2022-0183675 filed on Dec. 23, 2022, in the Korean Intellectual Property Office, the entire disclosure of which is incorporated herein by reference for all purposes.

### BACKGROUND

### 1. Field

The present invention relates to an antenna structure, and a motion recognition sensor, a radar sensor and an image display device including the same. More particularly, the present invention relates to an antenna structure including a plurality of radiators, and a motion recognition sensor, a radar sensor and an image display device including the same.

### 2. Description of the Related Art

As information technologies have been developed, a wireless communication technology such as Wi-Fi, Bluetooth, etc., or a non-contact sensing such as a gesture detection, a motion recognition, a distance measurement, a position detection, etc., is being applied to or embedded in image display devices, electronic devices and architecture.

Additionally, according to developments of mobile communication technology, an antenna for performing a communication in high-frequency or ultra-high-frequency band is applied or built into various mobile devices, Internet of Things (IoT), autonomous vehicles, etc. For example, wireless communication technology is being implemented in the form of a smartphone in combination with an image display device. In this case, the antenna may be coupled to the image display device to perform a communication function, an information transmission function, etc.

As the display device to which the antenna is employed becomes thinner and lighter, a space for the antenna may also decrease. Accordingly, the antenna may be included in the form of a film or patch on a display panel so as to insert the antenna in a limited space.

However, in the communication in the ultra-high frequency band of 5G higher, signal transmission and reception may be blocked, or signal loss/attenuation may occur as a wavelength becomes shorter. Further, as the antenna has a thin structure due to the limited space, desired radiation properties may not be easily implemented in the high frequency band. Therefore, construction of an antenna structure for improving radiation reliability even in a thin structure is needed.

### SUMMARY

According to an aspect of the present invention, there is provided an antenna structure having improved signaling efficiency and sensitivity.

According to an aspect of the present invention, there is provided a motion sensor including the antenna structure.

According to an aspect of the present invention, there is provided a radar sensor including the antenna structure.

According to an aspect of the present invention, there is provided an image display device including the antenna structure.

(1) An antenna structure, including: a plurality of first antenna units arranged along a first direction; and a second antenna unit disposed in a second direction perpendicular to the first direction with respect to one of the first antenna units, wherein each of the first antenna units includes a first radiator, a first transmission line connected to the first radiator, and a first sub-ground disposed around the first transmission line, and the second antenna unit includes a second radiator and a second transmission line connected to the second radiator.

(2) The antenna structure of the above (1), wherein the first sub-ground extends to be parallel to the first transmission line.

(3) The antenna structure of the above (1), wherein a ratio of a length of the first sub-ground to a length of the first transmission line is in a range from 0.50 to 0.99.

(4) The antenna structure of the above (1), wherein the first sub-ground includes a pair of first sub-grounds with the first transmission line interposed therebetween.

(5) The antenna structure of the above (4), wherein a ratio of a separation distance between outermost sides of the pair of first sub-grounds to a width of the first radiator is 1.2 or more.

(6) The antenna structure of the above (1), wherein each of the first antenna units further includes a first signal pad connected to one end of the first transmission line, and a first ground pad disposed around the first signal pad.

(7) The antenna structure of the above (6), wherein the first sub-ground extends from the first ground pad toward the first radiator.

(8) The antenna structure of the above (7), wherein the first sub-ground is physically connected to the first ground pad.

(9) The antenna structure of the above (7), wherein a width of the first sub-ground is smaller than the width of the first ground pad.

(10) The antenna structure of the above (1), wherein the second antenna unit further includes a second sub-ground disposed around the second transmission line.

(11) The antenna structure of the above (1), wherein the second antenna unit includes a plurality of second antenna units arranged along the second direction.

(12) The antenna structure of the above (1), further including a third antenna unit arranged to be spaced apart from the plurality of first antenna units and the second antenna unit, wherein the third antenna unit includes a third radiator, a third transmission line connected to the third radiator, and a third sub-ground disposed around the third transmission line.

(13) The antenna structure of the above (12), further including a dielectric layer on which the plurality of first antenna units, the second antenna unit and the third antenna unit are disposed, and the plurality of first antenna units, the second antenna unit and the third antenna unit are disposed at the same level on the dielectric layer.

(14) The antenna structure of the above (13), wherein the first direction and the second direction are each inclined by a predetermined angle with respect to a width direction of the dielectric layer.

(15) The antenna structure of the above (12), wherein the plurality of first antenna units and the second antenna unit serve as a reception radiation unit, and the third antenna unit serves as a transmission radiation unit.

(16) A motion recognition sensor comprising the antenna structure according to the above-described embodiments.

(17) A radar sensor comprising the antenna structure according to the above-described embodiments.

(18) An image display device, including: a display panel; and the antenna structure according to the above-described embodiments disposed on the display panel.

(19) The image display device of the above (18), further including: a motion sensor driving circuit coupled to the antenna structure; and a flexible circuit board (FPCB) electrically connecting the antenna structure and the motion sensor driving circuit.

The antenna structure may include a plurality of antenna units. The antenna units may include a plurality of first antenna units arranged in a first direction and a second antenna unit arranged in a second direction with respect to one of the first antenna units. The first direction and the second direction may be perpendicular to each other. Accordingly, signal intensities in two directions perpendicular to each other may each be detected.

Each of the antenna units may include a radiator, a transmission line connected to the radiator and a sub-ground disposed around the transmission line. Accordingly, driving properties of the antenna unit may be improved, and radiation directivity and gain may be enhanced, so that signal sensitivity may be improved.

The antenna structure may further include a transmission radiation unit. The antenna structure may be electrically coupled to a motion sensor driving circuit or a radar processor through a circuit board. Thus, a signal change due to a sensing target may be transmitted to the motion sensor driving circuit or the radar processor, and positions and distances in all directions may be measured based on a collected signal information.

### BRIEF DESCRIPTION OF THE DRAWINGS

FIGS. 1 and 2 are a schematic cross-sectional view and a schematic plan view, respectively. illustrating an antenna structure in accordance with exemplary embodiments.

FIG. 3 is a schematic plan view illustrating an antenna structure in accordance with exemplary embodiments.

FIG. 4 is a schematic plan view illustrating an antenna structure in accordance with exemplary embodiments.

FIG. 5 is a schematic plan view illustrating an antenna structure in accordance with exemplary embodiments.

FIG. 6 is a schematic plan view illustrating an antenna structure in accordance with exemplary embodiments.

FIGS. 7 and 8 are a schematic plan view and a cross-sectional view, respectively, illustrating an image display device in accordance with exemplary embodiments.

FIG. 9 is a graph showing an antenna gain according to frequencies of antenna structures of Example 1 and Comparative Example.

FIGS. 10 and 11 are graphs showing beam widths of antenna structures of Example 1 and Comparative Example.

FIG. 12 is a graph showing an antenna gain according to frequencies of antenna structures of Examples 4 and 5.

### DETAILED DESCRIPTION OF THE EMBODIMENTS

According to exemplary embodiments of the present invention, an antenna structure including a plurality of radiators arranged in perpendicular angles.

According to exemplary embodiments of the present invention, a motion recognition sensor, a radar and an image display device including the antenna structure are also provided. However, an application of the antenna structure is not limited thereto, and the antenna structure may be applied to various objects or structures such as a vehicle, a home electronic appliance, an architecture, etc.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “third”, “fourth”, “one end”, “other end”, “upper side”, “lower side”, “upper side”, “lower side”, etc., as used herein are not intended to limit an absolute position or order, but is used in a relative sense to distinguish different components or elements.

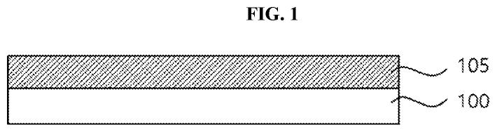

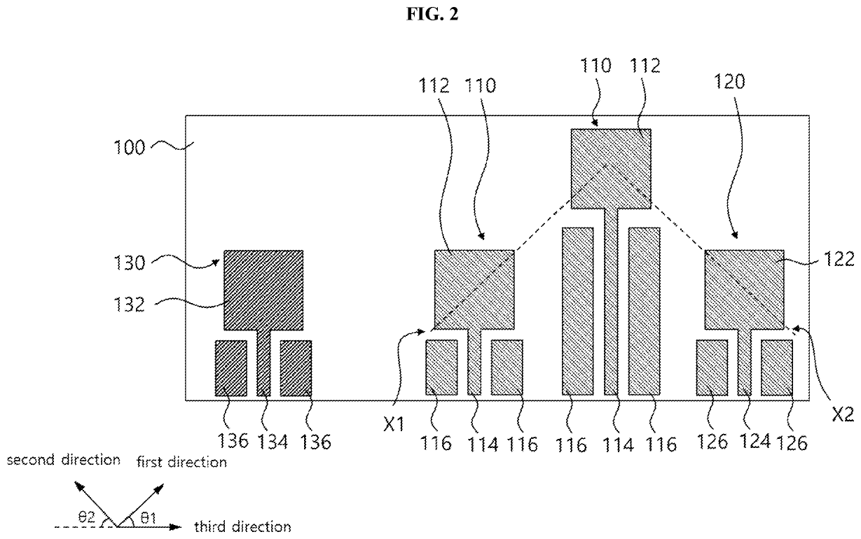

FIGS. 1 and 2 are a schematic cross-sectional view and a schematic plan view, respectively. illustrating an antenna structure in accordance with exemplary embodiments.

Referring to FIG. 1, the antenna structure may include a dielectric layer 100 and a conductive layer 105 disposed on atop surface of the dielectric layer 100.

The dielectric layer 100 may include, e.g., a transparent resin material. For example, the dielectric layer 100 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more thereof.

The dielectric layer 100 may include an adhesive material such as an optically clear adhesive (OCA), an optically clear resin (OCR), or the like.

In some embodiments, the dielectric layer 100 may include an inorganic insulating material such as glass, silicon oxide, silicon nitride, silicon oxynitride, etc.

In an embodiment, the dielectric layer 100 may be provided as a substantially single layer.

In an embodiment, the dielectric layer 100 may include a multi-layered structure of at least two layers. For example, the dielectric layer 100 may include a substrate layer and an antenna dielectric layer, and may include an adhesive layer between the substrate layer and the antenna dielectric layer.

Capacitance or inductance for the antenna structure may be formed by the dielectric layer 100, so that a frequency band at which the antenna structure may be driven or operated may be adjusted. In some embodiments, a dielectric constant of the dielectric layer 100 may be adjusted in a range from about 1.5 to about 12. If the dielectric constant exceeds about 12, a driving frequency may be excessively decreased, and driving in a desired high frequency or ultrahigh frequency band may not be implemented.

In some embodiments, a ground layer may be disposed on a bottom surface of the dielectric layer 100. Generation of an electric field in a transmission line may be easily promoted by the ground layer, and an electrical noise around the transmission line may be absorbed or shielded.

In some embodiments, the ground layer may be included an individual member of the antenna structure. In some embodiments, a conductive member of an image display device to which the antenna structure is applied may serve as the ground layer.

For example, the conductive member may include various electrodes or wirings such as, e.g., a gate electrode, a source/drain electrode, a pixel electrode, a common electrode, a scan line, a data line, etc., included in a thin film transistor (TFT) array of a display panel.

In an embodiment, a metallic member disposed at a rear portion of the image display device such as a SUS plate, a sensor member such as a digitizer, a heat dissipation sheet, etc., may serve as the ground layer.

Referring to FIG. 2, the conductive layer 105 may include a plurality of antenna units. The antenna units may include first antenna units 110 and a second antenna unit 120 physically spaced apart from each other.

Each of the first antenna units 110 may include a first radiator 112 and a first transmission line 114 connected to the first radiator 112. The second antenna unit 120 may include a second radiator 122 and a second transmission line 124 connected to the second radiator 122.

In example embodiments, the first antenna units 110 may be arranged on the dielectric layer 100 in a first direction. For example, the first radiators 112 may be disposed to be spaced apart from each other along a first axis X1 extending in the first direction. The first axis X1 may be an imaginary straight line passing through centers of the first radiators 112 and extending in the first direction.

The second antenna unit 120 may be adjacent to one of the first antenna units 110.

In an embodiment, the second antenna unit 120 may be disposed in a second direction perpendicular to the first direction with respect to the first antenna unit 110. For example, the second radiator 122 may be spaced apart from the first radiator 112 along a second axis X2 extending in the second direction. The second axis X2 may be an imaginary straight line passing through the center of any one of the first radiators 112 and a center of the second radiator 122 and extending in the second direction. In an embodiment, a plurality of the second antenna units 120 may be arranged along the second direction.

Each of the first radiators 112 and the second radiator 122 may be driven independently from each other. Accordingly, signal intensities according to positions or distances in the first and second directions of the sensing object may be sensed or measured. Accordingly, an action and a moving distance of the sensing object may be detected by measuring a signal change in each direction.

In some embodiments, the first direction and the second direction may vertically cross each other. Accordingly, the antenna structure may detect an electromagnetic signal along two orthogonal axes X1 and X2, and transmit a signal change in two orthogonal directions to a motion sensor driving circuit or a radar processor. The driving circuit or processor may measure a position change or a distance of the sensing object in all directions on the X-Y coordinate system based on the collected information.

For example, the antenna structure may be provided as a motion sensor that detects motions or gestures on two axes perpendicular to each other, or may be used for a radar to detect distances. The first antenna units 110 and the second antenna unit 120 may be provided as reception radiation units for the detection of the motion or the distance. For example, the first and second radiators 112 and 122 may receive a signal reflected from the sensing object.

The first radiator 112 disposed in a region where the first axis X1 and the second axis X2 intersect may serve as a reference point for measuring a change of the signal intensity. For example, a positional change of the sensing object may be detected by measuring the change of the signal intensities in the first axis X1 and the second axis X2 based on the signal intensity detected by the first radiator 112 disposed at the intersection.

In some embodiments, each of the first and second radiators 112 and 122 may be designed to have a resonance frequency in a high frequency or ultra-high frequency band of, e.g., 3G, 4G, 5G, or more. In one embodiment, the resonance frequency of each of the first and second radiators 112 and 122 may be about 50 GHz or more, e.g., from 50 GHz to 80 GHz, or from 55 GHz to 77 GHz.

The antenna structure may further include a third antenna unit 130 spaced apart from the first antenna unit 110 and the second antenna unit 120.

The third antenna unit 130 may include a third radiator 132 and a third transmission line 134 connected to the third radiator 132.

The third antenna unit 130 may be provided as a transmission radiation unit of the antenna structure. For example, the third radiator 132 may emit an electromagnetic wave toward the sensing object, and the first radiator 112 and the second radiator 122 may receive the electromagnetic wave reflected from the sensing object.

Each of the first antenna units 110 may include a first sub-ground 116 disposed around the first transmission line 114.

In an embodiment, the second antenna unit 120 may include a second sub-ground 126 disposed around the second transmission line 124. In an embodiment, the third antenna unit 130 may also include a third sub-ground 136 disposed around the third transmission line 134.

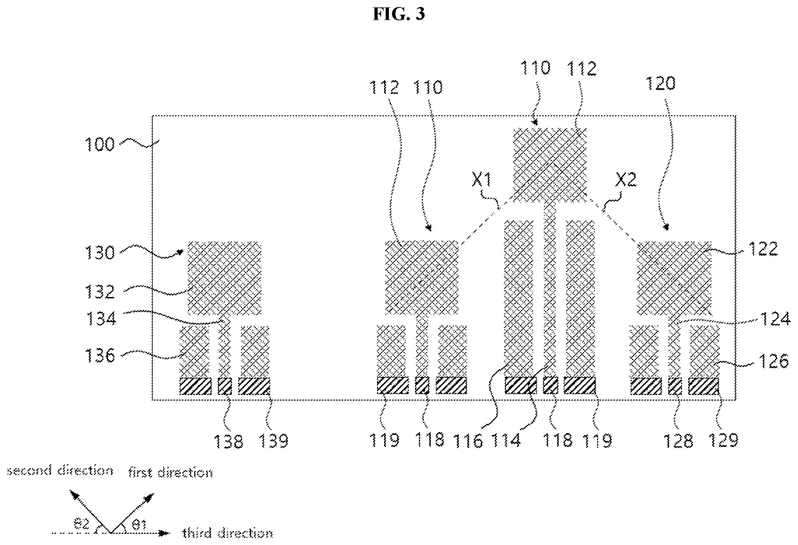

Hereinafter, the first sub-ground 116 will be described based on the first antenna unit 110, but the technical concepts described with reference to FIGS. 2 and 3 may also be applied to the second antenna unit 120, the second sub-ground 126, and/or the third antenna unit 130 and the third sub-ground 136.

The first sub-ground 116 may be physically spaced apart from the first radiator 112 and the first transmission line 114. In an embodiment, the first sub-ground 116 may extend to be parallel to the extending direction of the first transmission line 114.

In an embodiment, a pair of the first sub-grounds 116 may be disposed to be spaced apart from each other with the first transmission line 114 interposed therebetween. The first sub-ground 116 may be adjacent to the first transmission line 114 so that a gain and a beam width of the antenna structure may be improved.

When the antenna structure is adjacent to, e.g., a high dielectric constant structure, e.g., a window of an image display device, a beam pattern of the antenna unit may be deformed or a signal distortion may occur. Accordingly, the directivity of the antenna structure may be deteriorated, and the antenna gain in a reference direction (boresight), e.g., the direction toward the sensing object, may be lowered. Further, a parasitic capacitance may be generated between the radiator and an end of the transmission line, which may disturb a frequency band of the antenna unit and reduce sensitivity.

In example embodiments, a strong electromagnetic field may be generated in a region between an end of the first transmission line 114 (e.g., a bonding portion with a circuit board) and the first radiator 112 by the first sub-ground 116. Thus, an intensity of the electromagnetic field in a direction toward the circuit board may be increased, thereby improving the radiation directivity of the antenna unit and increasing a beam width.

An additional radiation or an auxiliary radiation may be provided by the first sub-ground 116, thereby further enhancing the antenna gain and the radiation directivity (e.g., vertical radiation properties). Thus, even in the ultra-high frequency band of 50 GHz or higher, the antenna structure may have high signal efficiency and sensitivity, and sensing performance and accuracy may be improved.

FIG. 3 is a schematic plan view illustrating an antenna structure in accordance with exemplary embodiments.

Referring to FIG. 3, the first antenna unit 110 may include a first signal pad 118 disposed at one end of the first transmission line 114.

In an embodiment, the first antenna unit 110 may further include a pair of first ground pads 119 spaced apart from each other with the first signal pad 118 interposed therebetween. The first ground pads 119 may be electrically and physically separated from the first signal pad 118.

In an embodiment, the second antenna unit 120 may include a second signal pad 128 disposed at one end of the second transmission line 124 and a pair of second ground pads 129 spaced apart from each other with the second signal pad 128 interposed therebetween.

In an embodiment, the third antenna unit 130 may include a third signal pad 138 disposed at one end of the third transmission line 134 and a pair of third ground pads 139 spaced apart from each other with the third signal pad 138 interposed therebetween.

The first sub-ground 116 may extend from the first ground pad 119. In one embodiment, the first sub-ground 116 and the first ground pad 119 may be formed as a single member integrally connected to each other. For example, the first sub-ground 116 may extend from the first ground pad 119 toward the first radiator 112.

The first sub-ground 116 may have the same shape as that of the first ground pad 119. For example, when the first ground pad 119 has a quadrangle shape, the first sub-ground 116 may also have a quadrangle shape. The same shape refers that an outer shape is the same, and a size and an area may be different.

In some embodiments, a width of the first sub-ground 116 (e.g., a length in the third direction) may be less than or equal to a width of the first ground pad 119. For example, the first sub-ground 116 may have a width smaller than that of the first ground pad 119.

In an embodiment, the first signal pad 118 may be formed as a substantially integral member with the first transmission line 114. For example, a terminal end portion of the first transmission line 114 may serve as the first signal pad 118.

In some embodiments, the first signal pad 118 and the second signal pad 128 may be arranged along the width direction of the dielectric layer 100, e.g., in the third direction.

The first signal pad 118 and the second signal pad 128 may be arranged along the same line, feeding directions for the first radiator 112 and the second radiator 122 may be parallel to each other. Thus, the first antenna unit and the second antenna unit may have the same polarization direction, so that signal sensitivity in the first and second directions may become uniform, and sensing performance and sensitivity may be improved.

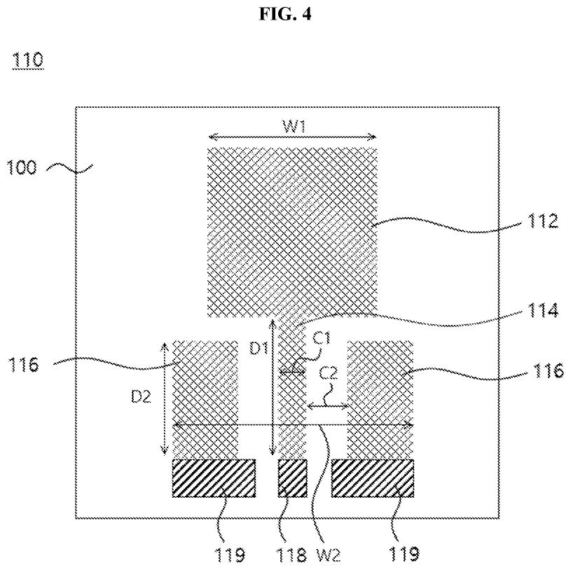

FIG. 4 is a schematic plan view illustrating an antenna structure in accordance with exemplary embodiments.

FIG. 4 illustrated only the first antenna unit 110. However, technical concepts described with reference to FIG. 4 may also be applied to the second antenna unit 120 and the third antenna unit 130.

For example, descriptions on the first sub-ground 116 may also be applied to the second sub-ground 126 or the third sub-ground 136. In this case, the first radiator 112 may correspond to the second radiator 122 or the third radiator 132, and the first transmission line 114 may correspond to the second transmission line 124 or the third transmission line 134.

In example embodiments, a ratio D2/D1 of a length D2 of the first sub-ground 116 to a length D1 of the first transmission line 114 may be in a range from 0.50 to 0.99.

For example, the first antenna unit 110 may satisfy Equation 1.

0.50≤D2/D1<0.99 [Equation 1]

The length of the first transmission line 114 and the length of the first sub-ground 116 may be adjusted to the above-described range, so that a strong electromagnetic field may be formed between the first signal pad 118 and the first radiator 112. For example, the first sub-ground 116 may cover at least half of the first transmission line 114 in the length direction, so that a strong electric field may be formed, and the radiation efficiency and the antenna gain may be increased.

In an embodiment, D2/D1 in Equation 1 may be greater than 0.50 and less than or equal to 0.99, from 0.60 to 0.99, or from 0.80 to 0.99. Within the above range, radiation directivity and signal sensitivity may be further improved.

In some embodiments, a ratio C2/C1 of a separation distance C2 between the first transmission line 114 and the first sub-ground 116 relative to a width C1 of the first transmission line 114 may be greater than or equal to 0.1.

For example, the first antenna unit 110 may satisfy Equation 2.

0.1≤C2/C1 [Equation 2]

A sufficient space may be achieved between the first transmission line 114 and the first sub-ground 116, so that a mutual interference between the first transmission line 114 and the first sub-ground 116 may be prevented. Accordingly, noise generation and signal distortion due to the first sub-ground may be suppressed, and the radiation efficiency and gain may be further improved.

In an embodiment, C2/C1 in Equation 2 may be in a range from 0.1 to 5.0, e.g., from 0.2 to 3.0, or from 0.5 to 1.5. Within the above range, the antenna radiation efficiency and directivity may be further improved, and high-gain radiation properties may be provided.

In some embodiments, a ratio W2/W1 of a separation distance W2 between outermost sides of the pair of the first sub-grounds 116 relative to a width W1 of the first radiator 112 may be greater than or equal to 1.2.

For example, the first antenna unit 110 may satisfy Equation 3.

1.2≤W2/W1 [Equation 3]

Within the above range, the first sub-grounds 116 may cover the first radiator 112 in the width direction, thereby forming a strong electromagnetic field around the first radiator 112. Accordingly, signal sensitivity of the antenna structure may be further improved.

In an embodiment, W2/W1 in Equation 3 may be greater than 1.23, e.g., from 1.25 to 2.0, or from 1.25 to 1.50.

In an embodiment, the second antenna unit 120 and the third antenna unit 130 may also satisfy Equations 1, 2, and/or 3. In this case, the first radiator 112, the first transmission line 114, and the first sub-ground 116 described in Equations 1 to 3 may correspond to the second radiator 122, the second transmission line 124, and the second sub-ground 126, respectively, or the third radiator 132, the third transmission line 134, and the third sub-ground 136, respectively.

In some embodiments, the first transmission line 114, the second transmission line 124, and the third transmission line 134 may be disposed on the dielectric layer 100 at the same layer or the same level as that of the first radiator 112, the second radiator 122, and the third radiator 132, respectively.

The transmission lines 114, 124 and 134 may be arranged at the same level as that of the radiators 112, 122, and 132, so that the radiators 112, 122, and 132 may be fed and driven without a separate coaxial power supply for signal input/output and feeding. Thus, the antenna structure may be applied as, e.g., an antenna on display (AoD) in which the antenna structure is placed on the display panel.

In some embodiments, the first transmission line 114, the second transmission line 124 and the third transmission line 134 may be disposed at different layers or different levels on the dielectric layer 100 from that of the first radiator 112, the second radiator 122 and the third radiator 132, respectively. In this case, the transmission lines 114, 124, and 134 and the radiators 112, 122, and 132 may be electrically connected to each other through a via.

In example embodiments, the first axis X1 and the second axis X2 may be inclined at a predetermined angle with respect to the width direction of the dielectric layer 100. For example, the first direction may be inclined by a first tilting angle θ1 with respect to the width direction (e.g., the third direction) of the dielectric layer 100, and the second direction may be inclined by a second tilting angle θ2 with respect to the width direction of the dielectric layer 100.

Accordingly, the lengths of the transmission lines 114 and 124 may be reduced, and signal loss and resistance increase may be prevented. Additionally, a length difference between the transmission lines 114 and 124 may be reduced, so that measurement or detection accuracy may be improved.

For example, as the length difference between the transmission lines 114 and 124 increases, a resistance deviation between the adjacent antenna units 110 and 120 may be increased. Accordingly, measurement deviation or error may be increased in a process of transmitting a signal from each of the antenna units 110 and 120 to the driving circuit or processor.

In some embodiments, the first tilting angle θ1 and the second tilting angle θ2 may each be in a range from 15° to 75°, preferably from 30° to 60°, and may each be, e.g., 45°. Within the above range, the radiators 112 and 122 may be arranged substantially symmetrically on the same plane, so that measurement error may be reduced.

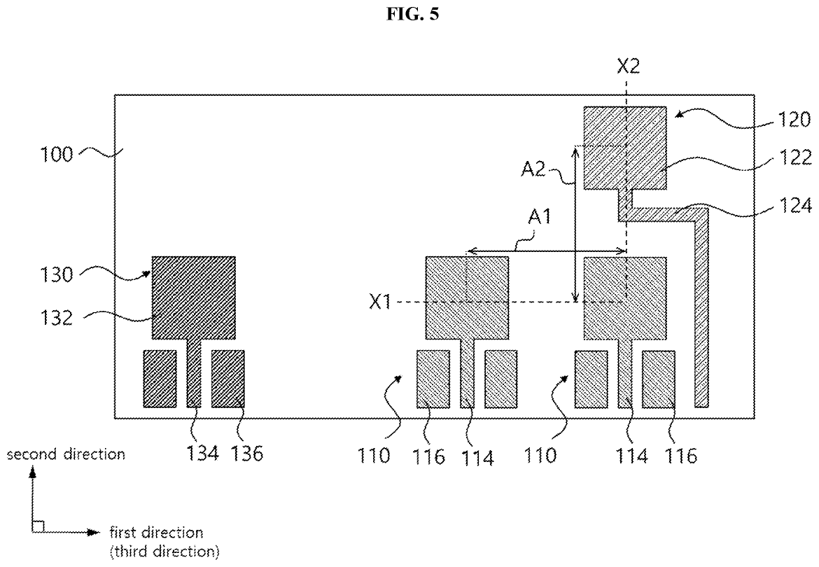

FIG. 5 is a schematic plan view illustrating an antenna structure in accordance with exemplary embodiments.

Referring to FIG. 5, a first direction may be parallel to a width direction (e.g., a third direction) of the dielectric layer 100. A second direction may be perpendicular to the width direction of the dielectric layer 100.

The second transmission line 124 may have a bent portion. Thus, feeding directions for the radiators 112 and 122 may be parallel to each other while preventing interference and signal disturbance to the radiators 112 and 122 neighboring each other.

In an embodiment, the first antenna unit 110 may include the first sub-ground 116, and the second antenna unit 120 may not include the second sub-ground 126.

In example embodiments, a separation distance between the radiators 112 and 122 (e.g., a distance between centers of the radiators) may be greater than or equal to 80% of a half wavelength (λ/2) of a maximum resonance frequency. The separation distances A1 and A2 between the radiators 112 and 122 may refer to the shortest linear distance connecting the centers of the radiators 112 and 122.

In an embodiment, the separation distances A1 and A2 between the radiators 112 and 122 adjacent to each other may be 90% or more, or 95% or more of the half wavelength (λ/2) of a maximum resonance frequency among resonance frequencies of the antenna structure. For example, the radiators 112 and 122 may be spaced apart from each other by the half wavelength (λ/2) or more.

In an embodiment, the separation distances A1 and A2 between the radiators 112 and 122 adjacent to each other may be 150% or less, 120% or less, or 110% or more of the half wavelength λ/2 of the maximum resonance frequency. For example, the radiators 112 and 122 may be spaced apart from each other by the half wavelength of the maximum resonance frequency.

For example, the separation distance A1 between the first radiators 112 adjacent to each other may be set to a half wavelength of a wavelength corresponding to a maximum resonance frequency in the first direction. For example, the separation distance A2 between the first and second radiators 112 and 122 adjacent to each other may be set to a half wavelength of a wavelength corresponding to a maximum resonance frequency in the second direction.

Accordingly, a desired type of radiation properties may be achieved while preventing the mutual interference between the antenna units 110 and 120. Thus, high sensitivity and accuracy may be implemented in, e.g., motion or distance sensing by preventing signal loss and signal distortion.

In some embodiments, the third antenna unit 130 may include a plurality of third antenna units 130 spaced apart from each other.

Each of the third antenna units 130 may include a third sub-ground 136. For example, each of the third antenna units 130 may include a pair of the sub-grounds 136 adjacent to each other with the third transmission line 134 interposed therebetween.

For example, when a plurality of transmission radiation units are densely arranged, multiple null points may occur around the antenna structure due to an offset interference between emitted electromagnetic waves. Accordingly, the radiation directivity and efficiency of the antenna structure may be deteriorated.

In example embodiments, the signal interference and disturbance between a plurality of the third antenna units 130 may be suppressed by the third sub-ground 136. Thus, the gain of the antenna structure may be improved, and noise generation may be prevented.

In example embodiments, the conductive layer 105 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy containing at least one of the above-mentioned metals. These may be used alone or in a combination of two or more therefrom.

In one embodiment, the conductive layer 105 may include silver (Ag) or a silver alloy (e.g., a silver-palladium-copper (APC) alloy), or copper (Cu) or a copper alloy (e.g., a copper-calcium (CuCa) alloy) for low resistance implementation and fine line width patterning.

In some embodiments, the conductive layer 105 may include a transparent conductive oxide such as indium tin oxide (ITO), indium zinc oxide (IZO), indium tin zinc oxide (ITZO), zinc oxide (ZnOx), etc.

In some embodiments, the antenna unit 110 may include a stacked structure of a transparent conductive oxide layer and a metal layer. For example, the conductive layer 105 may include a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The conductive layer 105 may include a blackened portion, so that a reflectance at a surface of the conductive layer 105 may be decreased to suppress a visual recognition of the antenna unit due to a light reflectance.

In an embodiment, a surface of the metal layer included in the conductive layer 105 may be converted into a metal oxide or a metal sulfide to form a blackened layer. In an embodiment, a blackened layer such as a black material coating layer or a plating layer may be formed on the metal layer. The black material or plating layer may include silicon, carbon, copper, molybdenum, tin, chromium, nickel, cobalt, or an oxide, sulfide or alloy containing at least one therefrom.

A composition and a thickness of the blackened layer may be adjusted in consideration of a reflectance reduction effect and an antenna radiation property.

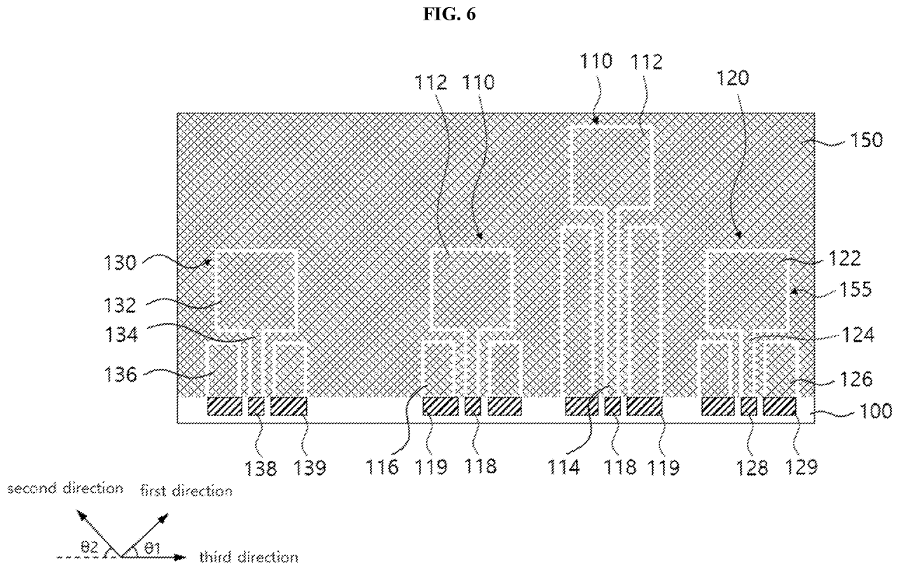

FIG. 6 is a schematic plan view illustrating an antenna structure in accordance with exemplary embodiments.

Referring to FIG. 6, each of the first radiator 112, the second radiator 122 and the third radiator 132 may have a mesh structure. Accordingly, optical transmittance of the antenna structure may be improved.

In example embodiments, the radiators 112, 122 and 132, the transmission lines 114, 124 and 134, and the sub-grounds 116, 126 and 136 may entirely include the mesh structure.

In an embodiment, at least a portion of the transmission lines 114, 124 and 134 may include a solid structure to improve driving properties of the antenna structure, improve impedance matching and feeding efficiency. For example, end portions of the transmission lines 114, 124, and 134 may have a solid structure. In this case, the end portions of the transmission lines 114, 124, and 134 may serve as a bonding region with the circuit board.

In some embodiments, when portions of the transmission lines 114, 124 and 134 have the solid structure, portions of the sub-grounds 116 126, and 136 may also have a solid structure.

In some embodiments, the signal pads 118, 128 and 128, and the ground pads 119, 129 and 139 may have a solid structure. For example, the signal pads 118, 128 and 128, and the ground pads 119, 129 and 139 may serve as the bonding region to the circuit board.

In some embodiments, the antenna structure may further include a dummy mesh pattern 150 disposed around the antenna units 110, 120 and 130. For example, the dummy mesh pattern 150 may be electrically and physically separated from radiators 112, 122 and 132, and the sub-grounds 116, 126 and 136 by a separation region 155.

For example, the conductive layer 105 including the above-described metal or alloy may be formed on the dielectric layer 100. A mesh structure may be formed while etching the conductive layer 105 along outer peripheries of the antenna units 110, 120 and 130 as described above. Accordingly, the dummy mesh pattern 150 spaced apart from the antenna units 110 120 and 130 by the separation region 155 may be formed.

The dummy mesh pattern 150 may be distributed, so that transmittance of the antenna structure may be improved, and optical properties around the radiators 112, 122 and 132 may become uniform. Thus, the antenna structure and a pattern shape thereof may be prevented from being visually recognized.

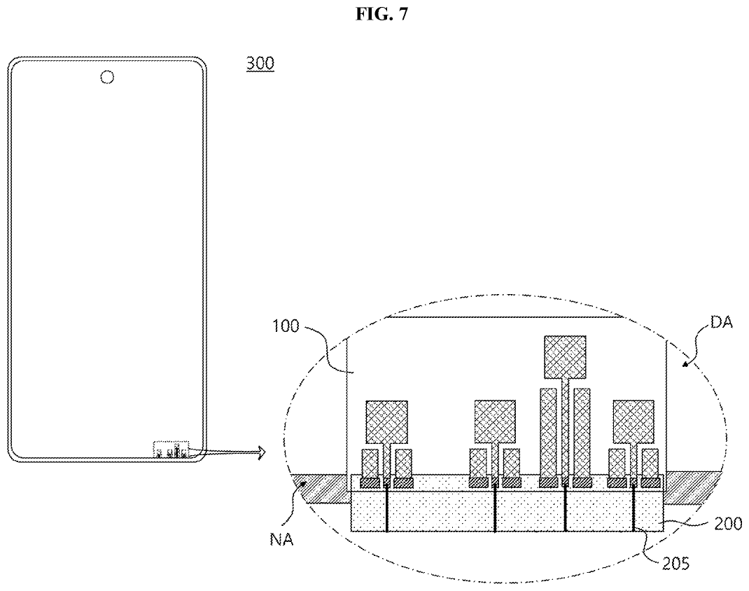

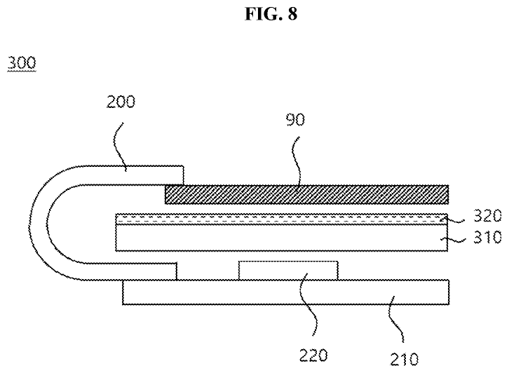

FIGS. 7 and 8 are a schematic plan view and a cross-sectional view, respectively, illustrating an image display device in accordance with exemplary embodiments.

FIG. 7 shows a front portion or a window surface of an image display device 300. The front portion of the image display device 300 may include a display area DA and a non-display area NA. The non-display area NA may correspond to, e.g., a light-shielding portion or a bezel portion of the image display device 300.

The antenna structure according to example embodiments may be disposed toward the front portion of the image display device 300, and may be disposed on, e.g., a display panel. Thus, the antenna structure may detect distance, position or motion of a sensing object on the front portion of the image display device 300.

In some embodiments, the antenna structure may be attached to the display panel in the form of a film.

In an embodiment, the antenna structure may be formed commonly over the display area DA and the non-display area NA of the image display device 300. In an embodiment, the radiators 112, 122 and 132 may at least partially cover the display area DA in a plan view.

The signal pads 118, 128 and 128 and the ground pads 119, 129 and 139 may overlap the non-display area NA. For example, portions of the antenna units 110, 120 and 130 having the solid structure may be disposed in the non-display area NA.

Feeding or driving of the antenna structure may be performed through a circuit board 200.

The circuit board 200 may include, e.g., a flexible printed circuit board (FPCB). For example, a conductive bonding structure such as an anisotropic conductive film (ACF) may be bonded on the signal pads 118, 128 and 128, and then the circuit board may be heat-compressed on the conductive bonding structure.

The circuit board 200 may include a core layer and a circuit wiring 205 disposed on the core layer. The circuit wiring 205 may be bonded to the signal pads 118, 128 and 128, and may serve as an antenna feeding wiring. For example, one end of the circuit wiring 205 may be exposed to an outside, and the exposed one end of the circuit wiring 205 may be bonded on the signal pads 118, 128 and 128. Therefore, the circuit board 200 and the antenna units 110, 120 and 130 may be electrically connected to each other.

Referring to FIG. 8, the image display device 300 may include a display panel 310 and an antenna structure 90 being disposed on the display panel 310 and including the antenna unit.

In example embodiments, an optical layer 320 may be disposed on the display panel 310. For example, the optical layer 320 may be a polarizing layer including a polarizer or a polarizing plate.

In an embodiment, a cover window may be disposed on the antenna structure 90. The cover window may include, e.g., glass (e.g., ultra-Thin Glass (UTG)) or a transparent resin film. Accordingly, an external impact applied to the antenna structure may be reduced or alleviated.

For example, the antenna structure 90 may be disposed between the optical layer 320 and the cover window. The dielectric layer 100 and the optical layer 320 of the antenna structure 90 may be provided together as a dielectric layer of the radiators 112, 122 and 132. Accordingly, an appropriate dielectric constant may be obtained to sufficiently implement motion sensing performance of the antenna structure 90.

For example, the optical layer 320 and the antenna structure 90 may be stacked using a first adhesive layer, and the antenna structure 90 and the cover window may be stacked using a second point adhesive layer.

The circuit board 200 may be bent along a side curved profile of the display panel 310 to be disposed at a rear portion of the image display device 300, and may extend toward an intermediate circuit board 210 (e.g., a main board) on which a driving IC chip is mounted. The intermediate circuit board 210 may be, e.g., a rigid circuit board.

The circuit board 200 and the intermediate circuit board 210 may be bonded or interconnected through a connector, thereby implementing the feeding to the antenna structure 90 and the antenna driving control by the antenna driving IC chip.

In some embodiments, a motion sensor driving circuit 220 may be mounted on the intermediate circuit board 210. In one embodiment, the motion sensor driving circuit 220 may include a proximity sensor, a gesture sensor, an acceleration sensor, a gyroscope sensor, a position sensor, a magnetic sensor, etc.

For example, signal information of the antenna structure 90 may be transmitted to the motion sensor driving circuit 220 through the circuit board 200. Accordingly, a motion recognition sensor including the antenna structure may be provided.

In some embodiments, the first antenna unit 110, the second antenna unit 120 and the third antenna unit 130 may be coupled to the motion sensor driving circuit 220. Accordingly, signal intensities and signal changes in the first axis X1 and the second axis X2 of the antenna structure 90 may be transmitted/provided to the motion sensor driving circuit 220. Therefore, the motion sensor driving circuit 220 may measure a signal change between the first radiators 112 and a signal change between the first radiator 112 and the second radiators 122 corresponding to a motion of the sensing object.

For example, a motion of the sensing object in the first direction may be detected by the first radiators 112, and a motion of the sensing object in the second direction may be detected by the second radiator 122. Therefore, the signal change according to the motion/position of the sensing object on two axes perpendicular to each other may be provided from the antenna structure 90 to the motion sensor driving circuit 220, and action and motion according to each axis may be detected by the motion sensor driving circuit 220.

In an embodiment, the motion sensor driving circuit 220 may include a motion detection circuit. Signal information transmitted from the antenna structure 90 may be converted/calculated into location information or distance information through the motion detection circuit.

In an embodiment, the antenna structure 90 may be electrically connected to a radar sensor circuit. Accordingly, signal transmission/reception information may be transmitted to a radar processor. For example, the antenna structure 90 may be electrically connected to the radar processor through the circuit board 200 and the intermediate circuit board 210. Thus, the radar sensor including the antenna structure 90 may be provided.

The radar sensor may detect distance information on the sensing object by analyzing a transmission signal and a reception signal. For example, the antenna structure 90 may measure a distance to the sensing object by transmitting the transmission signal and receiving the reception signal reflected by the sensing object.

For example, the distance of the sensing object may be calculated by measuring a time required for the signal transmitted from antenna structure 90 to be reflected on the sensing object and be received again to antenna structure 90.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Experimental Example 1: Signal Performance Measurement by Sub-Ground

Antenna units having the structure shown in FIG. 5 were formed on a COP dielectric layer using a Cu alloy. A size of the radiator was 1.3 mm×1.75 mm and a length of the transmission line was 0.5 mm. Sub-grounds having a length of 0.4 mm were formed at both sides of the transmission line to manufacture an antenna structure of Example 1.

An antenna structure of Comparative Example was manufactured by the same method as that in Example 1, except that the sub-ground was not formed. A signal performance (dB) of the antenna structure was measured.

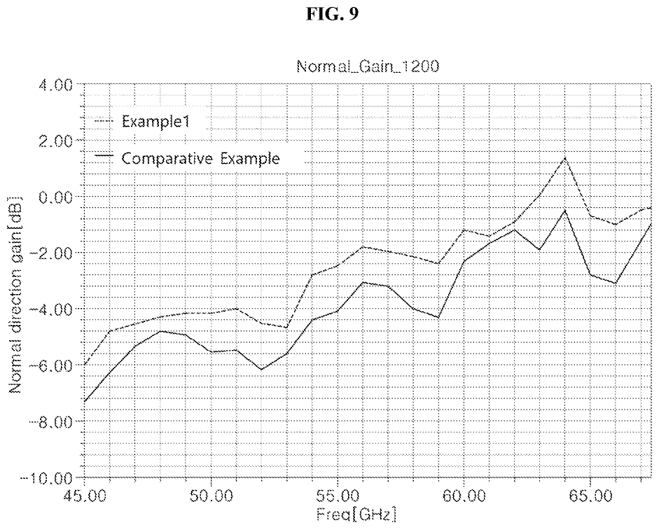

FIG. 9 is a graph showing an antenna gain in a vertical direction according to a frequency of the antenna structures of Example 1 and Comparative Example.

Referring to FIG. 9, in the antenna structure of Example 1, as sub-grounds were formed around the transmission line, the gain in the vertical direction was increased. In the antenna structure of Comparative Example, an overall antenna gain was low. For example, a gain amount at a resonance peak of 62 GHz to 64 GHz was explicitly reduced.

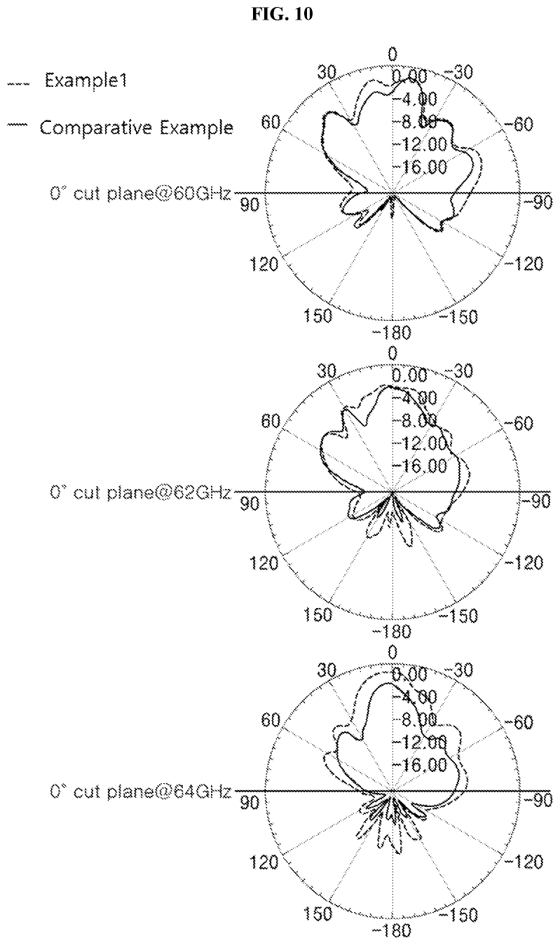

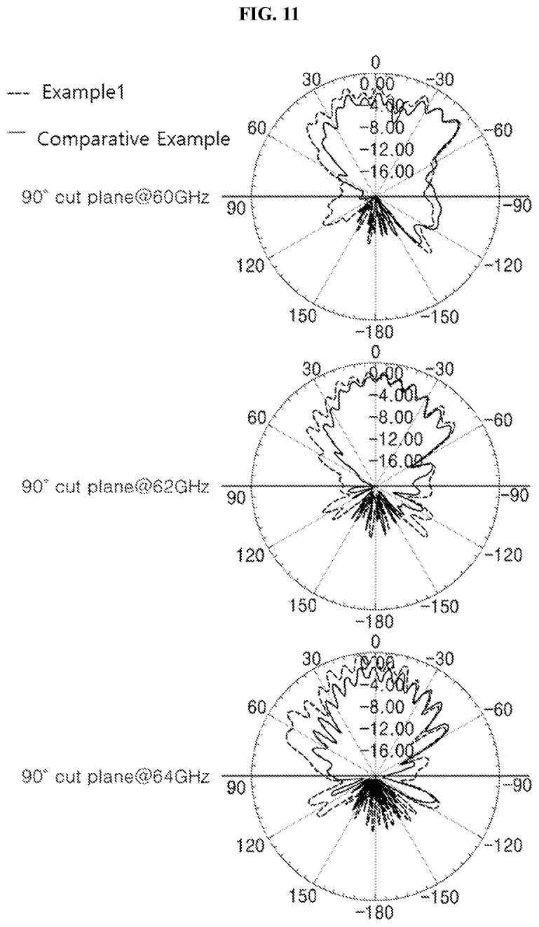

FIGS. 10 and 11 are graphs showing beam widths of the antenna structures of Example 1 and Comparative Example. In FIGS. 10 and 11, “x° cut plane@yGHz” designates a beam width at yGHz measured in an x° direction with respect to an antenna structure plane.

Referring to FIG. 10 and FIG. 11, the antenna structure of Example 1 had a larger beam width around 60 GHz in 0° and 90° directions compared to that from the antenna structure of Comparative Example. Therefore, the antenna structure of Embodiment 1 had a higher antenna gain than that from the antenna structure of Comparative example in boresight, and thus provide improved signal efficiency and sensing performance.

### Experimental Example 2: Measurement of Performance According to Length of Sub-Ground (D2)

The antenna structure of Example 2 was manufactured by the same method as that in Example 1, except that the length of the sub-ground was changed to 0.498 mm. Further, the antenna structure of Example 3 was manufactured by the same method as that Example 1, except that the length of the sub-ground was changed to 0.2 mm.

Antenna gains of the antenna structures of Examples and Comparative Example were measured. Measurement results are shown in Table 1 below.

TABLE 1

| | length of | length of | | | | |
|---|---|---|---|---|---|---|
| | transmission | sub-ground | | antenna gain (dB) | | |
| | line (D1) | (D2) | | 51 GHz | 55 GHz | 63 GHz |
| Example 1 | 0.5 mm | 0.4 | mm | −3.8 | −2.1 | 0.8 |
| Example 2 | 0.5 mm | 0.498 | mm | −2.8 | −1.2 | 0.0 |
| Example 3 | 0.5 mm | 0.2 | mm | −4.2 | −3.2 | −0.6 |

| | | | | | |
|---|---|---|---|---|---|
| Comparative | 0.5 mm | — | −5.5 | −4.4 | −1.9 |
| Example | | | | | |

Referring to Table 1 above, in Examples, relatively high antenna gain were obtained at each resonance peak (e.g., frequencies of 51 GHz, 55 GHz, 63 GHz).

In the antenna structures of Examples 1 and 2, the length of the sub-ground exceeded half of the length of the transmission line and showed a relatively high gain increase.

### Experimental Example 3: Measurement of Different Signal Performance in Sub-Ground Width (W2)

Antenna units having the structure shown in FIG. 5 were formed on a COP dielectric layer using Cu—Ca. The radiator was formed to have a length of 1.3 mm and a width (W1) of 1.75 mm, and the transmission line was formed to have a length of 0.5 mm. The sub-grounds having a length of 0.4 mm were formed so that the width (W2) between the sub-grounds at both sides of the transmission line became 2.156 mm to manufacture an antenna structure of Example 4.

An antenna structure of Example 5 was manufactured by the same method as that in Example 4, except that the width W2 between the sub-grounds was 2.497 mm. A signal performance (dB) of the antenna structure was measured.

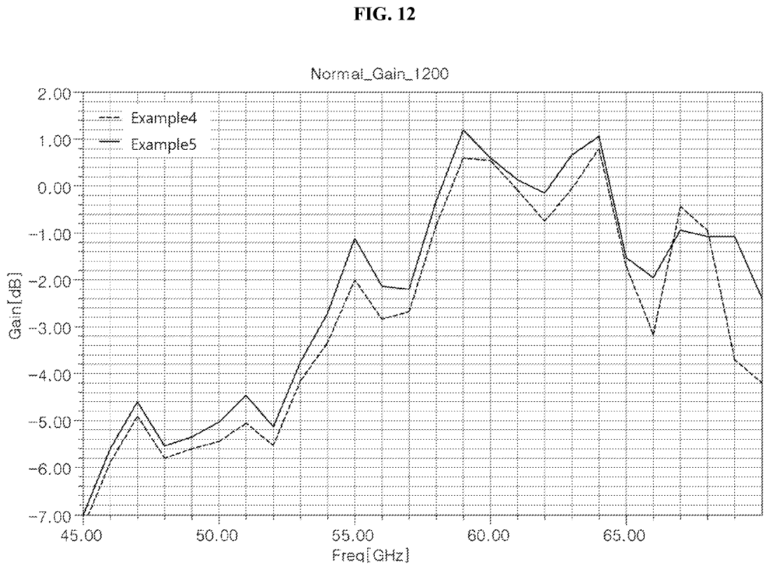

FIG. 12 is a graph showing an antenna gain in a vertical direction according to frequencies of the antenna structures of Examples 4 and 5.

Referring to FIG. 12, both the antenna structure of Example 4 and the antenna structure of Example 5 provided high gains in an ultra-high frequency range of 55 GHz or higher.

In Example 4, a ratio (W2/W1) of the sub-ground width to the radiator width was 1.232. In Example 5, the ratio (W2/W1) of the sub-ground width to the radiator width was 1.426. The antenna structure of Example 5 showed a relatively high antenna gain compared to that from the antenna structure of Example 4.

In Example 5, the sub-grounds covered a relatively large area between the radiator and the signal pad, and a higher electromagnetic field was formed between the radiator and the circuit board, thereby reducing the signal loss and further increasing the gain amount.

What is claimed is:

1. An antenna structure comprising:
a plurality of first antenna units arranged along a first direction; and
a second antenna unit disposed in a second direction perpendicular to the first direction with respect to one of the first antenna units,
wherein each of the first antenna units comprises a first radiator, a first transmission line connected to the first radiator, and a first sub-ground disposed around the first transmission line, and
the second antenna unit comprises a second radiator and a second transmission line connected to the second radiator.

2. The antenna structure of claim 1, wherein the first sub-ground extends to be parallel to the first transmission line.

3. The antenna structure of claim 1, wherein a ratio of a length of the first sub-ground to a length of the first transmission line is in a range from 0.50 to 0.99.

4. The antenna structure of claim 1, wherein the first sub-ground includes a pair of first sub-grounds with the first transmission line interposed therebetween.

5. The antenna structure of claim 4, wherein a ratio of a separation distance between outermost sides of the pair of first sub-grounds to a width of the first radiator is 1.2 or more.

6. The antenna structure of claim 1, wherein each of the first antenna units further comprises a first signal pad connected to one end of the first transmission line, and a first ground pad disposed around the first signal pad.

7. The antenna structure of claim 6, wherein the first sub-ground extends from the first ground pad toward the first radiator.

8. The antenna structure of claim 7, wherein the first sub-ground is physically connected to the first ground pad.

9. The antenna structure of claim 7, wherein a width of the first sub-ground is smaller than a width of the first ground pad.

10. The antenna structure of claim 1, wherein the second antenna unit further comprises a second sub-ground disposed around the second transmission line.

11. The antenna structure of claim 1, wherein the second antenna unit includes a plurality of second antenna units arranged along the second direction.

12. The antenna structure of claim 1, further comprising a third antenna unit arranged to be spaced apart from the plurality of first antenna units and the second antenna unit,
wherein the third antenna unit comprises a third radiator, a third transmission line connected to the third radiator, and a third sub-ground disposed around the third transmission line.

13. The antenna structure of claim 12, further comprising a dielectric layer on which the plurality of first antenna units, the second antenna unit and the third antenna unit are disposed, and
the plurality of first antenna units, the second antenna unit and the third antenna unit are disposed at the same level on the dielectric layer.

14. The antenna structure of claim 13, wherein the first direction and the second direction are each inclined by a predetermined angle with respect to a width direction of the dielectric layer.

15. The antenna structure of claim 12, wherein the plurality of first antenna units and the second antenna unit serve as a reception radiation unit, and the third antenna unit serves as a transmission radiation unit.

16. A motion recognition sensor comprising the antenna structure of claim 1.

17. A radar sensor comprising the antenna structure of claim 1.

18. An image display device, comprising:
a display panel; and
the antenna structure according to claim 1 disposed on the display panel.

19. The image display device of claim 18, further comprising:
a motion sensor driving circuit coupled to the antenna structure; and
a flexible circuit board (FPCB) electrically connecting the antenna structure and the motion sensor driving circuit.
